(19) United States
(12) Patent Application Publication
(10) Pub. No.: US 2008/0168350 A1
(43) Pub. Date: Jul. 10, 2008

(54) METHOD AND SYSTEM FOR MOVIE KARAOKE

(76) Inventor: David N. Jones, Beverly Hills, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/969,893

(22) Filed: Jan. 5, 2008

Related U.S. Application Data
(60) Provisional application No. 60/883,596, filed on Jan. 5, 2007.

(51) Int. Cl. G06F 3/00

(52) U.S. Cl. 715/704

(57) ABSTRACT

A user's recorded voice and/or image is played back in the context of a scene from a pre-recorded movie such that it replaces an actor's recorded voice and/or image of the pre-recorded movie, thus giving the illusion that the user is participating in the scene. The replacement may occur in real time (without storing the user-generated audio/video information), for example as the movie is playing to an audience or to the user, or using a stored version of the user-generated content. Script notes and/or subtitles may be provided to the user so that he can better understand the scene and thereby more accurately emulate the movie character which he will personify.

### RELATED APPLICATIONS

This application is a NONPROVISIONAL of, incorporates by reference and claims priority to U.S. Provisional Patent Application 60/883,596, filed 5 Jan. 2007.

### COMPUTER PROGRAM LISTING APPENDIX

Submitted herewith and incorporated herein by reference is a Computer Program Listing Appendix setting forth an embodiment of the present invention in computer source code files (listed below) that, for purposes of this disclosure, are collected in an ASCII file named “KaraMovie.txt” (file size: 1296 KB) that was created on 5 Jan. 2007. The following files (in ASCII version) are included in the KaraMovie.txt file:

| File Name | Type | Date modified | Size |
|---|---|---|---|
| About.cs | CS File | 11/28/2005 13:26 | 6,696 |
| About.cs | CS File | 11/28/2005 13:27 | 3,787 |
| About.resx | RESX File | 11/28/2005 13:26 | 8,131 |
| About.resx | RESX File | 11/28/2005 5:15 | 8,131 |
| AssemblyInfo.cs | CS File | 10/27/2005 11:39 | 2,426 |
| AssemblyInfo.cs | CS File | 10/10/2005 8:08 | 2,426 |
| AssemblyInfo.cs | CS File | 10/13/2005 11:27 | 2,426 |
| AssemblyInfo.cs | CS File | 10/23/2005 3:41 | 2,426 |
| AudioPlayer.cpp | CPP File | 7/16/2006 0:14 | 2,392 |
| AudioPlayer.def | DEF File | 10/23/2005 23:49 | 211 |
| AudioPlayer.h | H File | 11/30/2006 15:35 | 22,858 |
| AudioPlayer.idl | IDL File | 10/24/2005 0:09 | 3,617 |
| AudioPlayer.rc | RC File | 1/22/2006 12:22 | 3,836 |
| AudioPlayer.rgs | RGS File | 10/23/2005 23:47 | 127 |
| AudioPlayer.vcproj | VCPROJ File | 11/15/2006 23:32 | 7,215 |
| AudioPlayer_i.c | C File | 11/30/2006 15:35 | 2,060 |
| AudioPlayer_p.c | C File | 11/30/2006 15:35 | 32,733 |
| AudioPlayerServer.cpp | CPP File | 11/30/2006 15:33 | 35,490 |
| AudioPlayerServer.h | H File | 10/24/2005 1:07 | 6,499 |
| AudioPlayerServer.rgs | RGS File | 10/24/2005 0:11 | 687 |
| AudioProcessing.cs | CS File | 7/25/2006 16:58 | 9,140 |
| AudioProcessing.resx | RESX File | 1/11/2006 11:11 | 9,342 |
| AudioSettings.cs | CS File | 9/26/2006 23:13 | 19,915 |
| AudioSettings.resx | RESX File | 9/26/2006 23:13 | 21,208 |
| ColorConverter.cpp | CPP File | 8/2/2002 9:30 | 9,069 |
| ColorConverter.h | H File | 8/2/2002 9:30 | 3,113 |
| ControlFileManager.cs | CS File | 10/12/2006 23:34 | 14,841 |
| ControlFileManager.resx | RESX File | 10/12/2006 23:30 | 13,366 |
| ControlFileObject.cs | CS File | 1/22/2006 12:17 | 2,152 |
| ControlFileObject.csproj | CSPROJ File | 11/12/2006 19:55 | 6,272 |
| Cpu.cpp | CPP File | 7/7/2002 5:36 | 13,644 |
| Cpu.h | H File | 7/7/2002 5:36 | 2,929 |
| CreateImageSequence.cs | CS File | 10/1/2006 0:50 | 13,793 |
| CreateImageSequence.resx | RESX File | 10/1/2006 0:48 | 14,343 |
| DataFile.cpp | CPP File | 11/27/2005 13:36 | 2,843 |
| DataFile.def | DEF File | 11/27/2005 13:36 | 256 |
| DataFile.h | H File | 11/27/2005 13:36 | 450 |
| DataFile.idl | IDL File | 10/13/2006 0:26 | 3,785 |
| DataFile.rc | RC File | 1/22/2006 12:22 | 3,621 |
| DataFile.rc2 | RC2 File | 11/27/2005 13:36 | 399 |
| DataFile.vcproj | VCPROJ File | 11/15/2006 23:32 | 5,548 |
| DataFile_h.h | H File | 11/30/2006 15:35 | 5,471 |
| DataFile_i.c | C File | 11/30/2006 15:35 | 2,046 |
| DataFileServer.cpp | CPP File | 11/30/2006 15:33 | 28,715 |
| DataFileServer.h | H File | 10/13/2006 0:11 | 4,536 |
| DibHelper.cpp | CPP File | 11/12/2002 18:11 | 2,427 |
| DibHelper.h | H File | 11/12/2002 18:11 | 1,684 |
| dlldata.c | C File | 11/30/2006 15:35 | 843 |
| dlldata.c | C File | 11/30/2006 15:35 | 839 |
| dlldatax.c | C File | 10/23/2005 23:51 | 475 |
| dlldatax.c | C File | 7/8/2006 1:21 | 473 |
| dlldatax.h | H File | 9/24/2005 7:35 | 337 |
| dlldatax.h | H File | 7/8/2006 1:21 | 337 |
| DVDPlayerCtrl.cpp | CPP File | 10/12/2005 12:07 | 1,600 |
| DVDPlayerCtrl.def | DEF File | 3/6/2004 12:05 | 222 |
| DVDPlayerCtrl.h | H File | 3/6/2004 12:05 | 501 |
| DVDPlayerCtrl.ico | Icon | 11/21/2000 22:09 | 1,078 |
| DVDPlayerCtrl.idl | IDL File | 10/25/2006 23:53 | 4,524 |
| DVDPlayerCtrl.rc | RC File | 1/22/2006 12:22 | 2,840 |
| DVDPlayerCtrl.vcproj | VCPROJ File | 11/14/2006 1:02 | 6,095 |
| DVDPlayerCtrl_i.c | C File | 11/30/2006 15:36 | 2,179 |
| DVDPlayerCtrlCtrl.cpp | CPP File | 11/30/2006 15:33 | 100,663 |
| DVDPlayerCtrlCtrl.h | H File | 10/27/2006 0:12 | 11,334 |
| DVDPlayerCtrlidl.h | H File | 11/30/2006 15:36 | 9,169 |
| DVDSwitch.csproj | CSPROJ File | 11/12/2006 19:55 | 9,050 |
| DVDSwitch.sln | SLN File | 11/12/2006 19:55 | 15,302 |
| ExpiredForm.cs | CS File | 9/30/2006 22:13 | 3,944 |
| ExpiredForm.resx | RESX File | 9/30/2006 22:13 | 9,528 |
| Guids.h | H File | 7/2/2006 23:56 | 0 |
| iIlmagePlayer.h | H File | 7/3/2006 0:42 | 591 |
| ImagePlayer.def | DEF File | 7/2/2006 13:27 | 266 |
| ImagePlayer.h | H File | 7/2/2006 23:52 | 3,259 |
| ImagePlayer.rc | RC File | 11/12/2002 18:11 | 745 |
| ImagePlayer.vcproj | VCPROJ File | 11/15/2006 23:40 | 10,103 |
| ImagePlayerBitmapSet.cpp | CPP File | 11/30/2006 15:34 | 12,054 |
| IVideoProcessor.h | H File | 4/23/2006 13:44 | 1,511 |
| MainForm.cs | CS File | 11/30/2006 15:34 | 42,678 |
| MainForm.resx | RESX File | 10/26/2006 0:03 | 22,538 |
| ManagerForm.cs | CS File | 10/23/2006 10:46 | 129,397 |
| ManagerForm.resx | RESX File | 10/12/2006 22:48 | 101,212 |
| Options.cs | CS File | 9/28/2006 0:08 | 5,321 |
| Options.resx | RESX File | 9/28/2006 0:08 | 9,867 |
| resource.h | H File | 10/23/2005 23:47 | 592 |
| Resource.h | H File | 11/27/2005 13:36 | 380 |
| resource.h | H File | 11/27/2005 2:59 | 1,073 |
| Resource.h | H File | 10/27/2005 11:15 | 538 |
| resource.h | H File | 7/8/2006 1:22 | 541 |
| resource.h | H File | 11/14/2005 2:32 | 1,229 |
| ScrollingEditbox.cpp | CPP File | 11/20/2005 8:22 | 1,614 |
| ScrollingEditbox.def | DEF File | 10/27/2005 11:15 | 228 |
| ScrollingEditbox.h | H File | 10/27/2005 11:15 | 516 |
| ScrollingEditbox.idl | IDL File | 10/31/2005 3:49 | 1,512 |
| ScrollingEditbox.rc | RC File | 11/7/2005 13:58 | 3,043 |
| ScrollingEditbox.vcproj | VCPROJ File | 11/15/2006 23:32 | 5,852 |
| ScrollingEditbox_i.c | C File | 11/30/2006 15:36 | 2,194 |
| ScrollingEditboxCtrl.cpp | CPP File | 11/30/2006 15:34 | 6,269 |
| ScrollingEditboxCtrl.h | H File | 11/20/2005 8:34 | 1,514 |
| ScrollingEditboxidl.h | H File | 11/30/2006 15:36 | 9,404 |
| ScrollingEditboxPropPage.cpp | CPP File | 10/27/2005 11:15 | 1,536 |
| ScrollingEditboxPropPage.h | H File | 10/27/2005 11:15 | 656 |
| setup.cpp | CPP File | 7/2/2006 13:47 | 2,982 |
| Setup.Ini | Configuration | 11/14/2006 0:56 | 182 |
| | Setup File | | |
| Setup.vdproj | VDPROJ File | 11/12/2006 19:55 | 123,627 |
| SetupControlFile.vdproj | VDPROJ File | 11/12/2006 19:55 | 72,253 |
| SlideShow.cpp | CPP File | 7/8/2006 1:21 | 2,295 |
| SlideShow.def | DEF File | 7/8/2006 1:21 | 207 |
| SlideShow.h | H File | 11/30/2006 15:35 | 9,502 |
| SlideShow.idl | IDL File | 7/8/2006 1:25 | 1,179 |
| SlideShow.rc | RC File | 7/8/2006 1:22 | 3,324 |
| SlideShow.rgs | RGS File | 7/8/2006 1:21 | 123 |
| SlideShow.vcproj | VCPROJ File | 11/30/2006 15:32 | 7,045 |
| SlideShow_i.c | C File | 11/30/2006 15:35 | 2,052 |
| SlideShow_p.c | C File | 11/30/2006 15:35 | 13,002 |
| SlideShowServer.cpp | CPP File | 11/30/2006 15:34 | 7,166 |
| SlideShowServer.h | H File | 7/8/2006 1:33 | 1,167 |
| SlideShowServer.rgs | RGS File | 7/8/2006 1:22 | 681 |
| SplashScreen.cs | CS File | 5/1/2006 16:24 | 4,210 |
| SplashScreen.resx | RESX File | 5/1/2006 1:55 | 8,655 |
| stdafx.cpp | CPP File | 10/23/2005 23:52 | 207 |
| stdafx.cpp | CPP File | 11/27/2005 13:36 | 208 |
| stdafx.cpp | CPP File | 3/3/2005 9:02 | 215 |
| stdafx.cpp | CPP File | 10/27/2005 11:15 | 214 |
| stdafx.cpp | CPP File | 7/8/2006 1:21 | 205 |
| stdafx.h | H File | 9/27/2005 11:48 | 1,652 |
| stdafx.h | H File | 11/27/2005 13:36 | 2,124 |
| stdafx.h | H File | 10/12/2005 11:24 | 2,007 |
| stdafx.h | H File | 10/27/2005 11:15 | 1,866 |
| stdafx.h | H File | 7/8/2006 1:29 | 1,630 |
| stdafx.h | H File | 12/3/2005 11:18 | 0 |
| SwitchManager.csproj | CSPROJ File | 11/12/2006 19:55 | 7,639 |
| TimeControl.cs | CS File | 10/22/2006 2:04 | 12,978 |
| TimeControl.csproj | CSPROJ File | 11/12/2006 19:55 | 4,737 |
| TimeControl.resx | RESX File | 12/11/2005 12:46 | 13,686 |
| VideoProcessor.cpp | CPP File | 11/30/2006 15:35 | 13,071 |
| VideoProcessor.def | DEF File | 3/21/2005 5:43 | 268 |
| VideoProcessor.h | H File | 4/23/2006 13:44 | 2,334 |
| VideoProcessor.rc | RC File | 11/14/2005 2:47 | 2,490 |
| VideoProcessor.vcproj | VCPROJ File | 11/15/2006 23:45 | 14,038 |
| VideoProcessorOld.cpp | CPP File | 3/26/2006 10:41 | 44,255 |
| VideoProcessorUIDs.h | H File | 10/11/2004 12:03 | 446 |

### BACKGROUND

Karaoke (an English word translated from a Japanese phrase meaning, literally, “empty orchestra”) is a popular form of entertainment in which individuals sing along with pre-recorded musical scores while the lyrics to the song are displayed on a screen. This form of entertainment has become somewhat ubiquitous throughout the United States and karoke talent nights are sometimes used as means to entice patrons to a bar other establishment.

Movieoke is a related form of entertainment in which performs recite lines for a muted film, the video images of which are displayed in some fashion. Movieoke has been a popular form of entertainment since approximately 2003, when it was first introduced in New York, N.Y. Conventional movieoke, however, is limited to providing would-be actors and actresses with the chance to recite lines at appropriate times within the playback of a movie. It does not offer those participants the opportunity to become immersed in the scene.

### SUMMARY OF THE INVENTION

In one embodiment of the present invention, a user's recorded voice and/or image is played back in the context of a scene from a pre-recorded movie such that it replaces an actor's recorded voice and/or image of the pre-recorded movie, thus giving the illusion that the user is participating in the scene. The replacement may occur in real time (without storing the user-generated audio/video information), for example as the movie is playing to an audience or to the user, or using a stored version of the user-generated content. Script notes and/or subtitles may be provided to the user so that he can better understand the scene and thereby more accurately emulate the movie character which he will personify.

A further embodiment of the invention involves providing, in response to a request designating a scene of interest included in a media file, a control file including instructions for playing of audio and video portions of the scene of interest, which instructions when executed by a computer system, cause the computer system to play the audio and video portions intermixed with capture of user-generated audio and video information provided as inputs to the computer system at designated times during the playing of the audio and video portions. The control file may also include instructions that, when executed by the computer system, cause the computer system to display coaching text, such as subtitles highlighted so as to indicate when a user should speak lines of dialog appropriate to the scene of interest, and/or script notes regarding the scene of interest. Such script notes or other material may be provided to the computer system in a file separate from the control file. The request may specify the scene of interest as a selection from a list of scenes available for the media file.

In various embodiments of the invention, the instructions, when executed by the computer system, may cause the computer system to play the media file so as to render perceptible the audio and video portions at some times during the playing of the media file to render imperceptible the audio and video portions at other times during the playing of the media file. The user-generated audio information may thus be captured (e.g., recorded and stored, or sometimes simply played) during the times the audio portion of the media file is rendered imperceptible during playing of the media file. Audio and video portions of the user-generated content may be captured together, or separately from one another, according to the requirements of the scene of interest.

Still further embodiments of the invention involve playing a scene of interest from a media file so as to render perceptible audio and video portions of the scene of interest at some times during the playing of the media file and to render imperceptible the audio and video portions of the scene of interest at other times during the playing of the media file, and recording user-provided audio and video information during those times the audio and video portions of the scene of interest are rendered imperceptible during playing of the media file. Coaching text, such as subtitles or script notes, may be played or otherwise presented during the playing of the media file.

Additional embodiments of the present invention involve playing audio and video portions of a scene of interest of a media file and playing user-generated content, the playing of the audio and video portions and the user-generated content being arranged in time so that the audio and video portions of the scene of interest are rendered perceptible at and for first designated periods of time and are rendered imperceptible at and for second designated periods of time, and designated portions of the user-generated content are played during the second designated periods of time when the audio and video portions of the scene of interest are rendered imperceptible. The user-generated content may be played from a stored copy thereof or captured and played in real time as the scene is being played. In either instance, coaching text, such as subtitles and/or script notes, may be played or presented during the playing of the scene of interest.

Still further details of these and other embodiments of the invention are described below.

### BRIEF DESCRIPTION OF THE DRAWINGS

The present invention is illustrated by way of example, and not limitation, in the figures of the accompanying drawings, in which:

FIG. 1 illustrates an exemplary computer system upon which an embodiment of the invention may be implemented;

FIG. 2 is a flow diagram illustrating various aspects of a movieoke user experience in accordance with an embodiment of the present invention;

FIG. 3 illustrates a timeline of playback of a media file and capture of user-generated audio/video content in accordance with an embodiment of the present invention; and

FIG. 4 illustrates an example of the replay of a scene of interest to include user-generated content in accordance with an embodiment of the present invention.

### DETAILED DESCRIPTION

The present invention relates to methods and systems for enhanced movie karaoke or movieoke, that is, a user experience in which an actor's recorded voice and/or image in the context of a pre-recorded movie or other audio-video presentation (e.g., played back from a DVD or other medium) is replaced with the user's voice and/or image (e.g., as captured by a microphone and/or imaging device). The user's voice and/or image may be stored (e.g., on a digital storage device such as a computer system) and later played back so as to replace the actor's recorded voice and/or image during later playback of the pre-recorded movie, thus giving the illusion that the user is participating in the scene being displayed. In other embodiments the replacement may occur in real time (without storing the user generated audio/video information), for example as the movie is playing to an audience or to the user. A variety of features may be used to enhance the overall user experience in this regard. For example, script notes or other material may be provided to the user so that he/she can better understand the scene of the movie that will comprise the movieoke experience and thereby more accurately emulate the movie character which the user will personify. In addition, highlighted subtitles may be displayed during the initial playback of the pre-recorded movie so as to provide the user with visual clues regarding his/her dialog. These and other features of the present invention will be more fully described below.

Various embodiments of the present invention may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

In view of the above, it should be appreciated that some portions of the description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. Moreover, the present invention is compatible with any form of audio/video codec.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

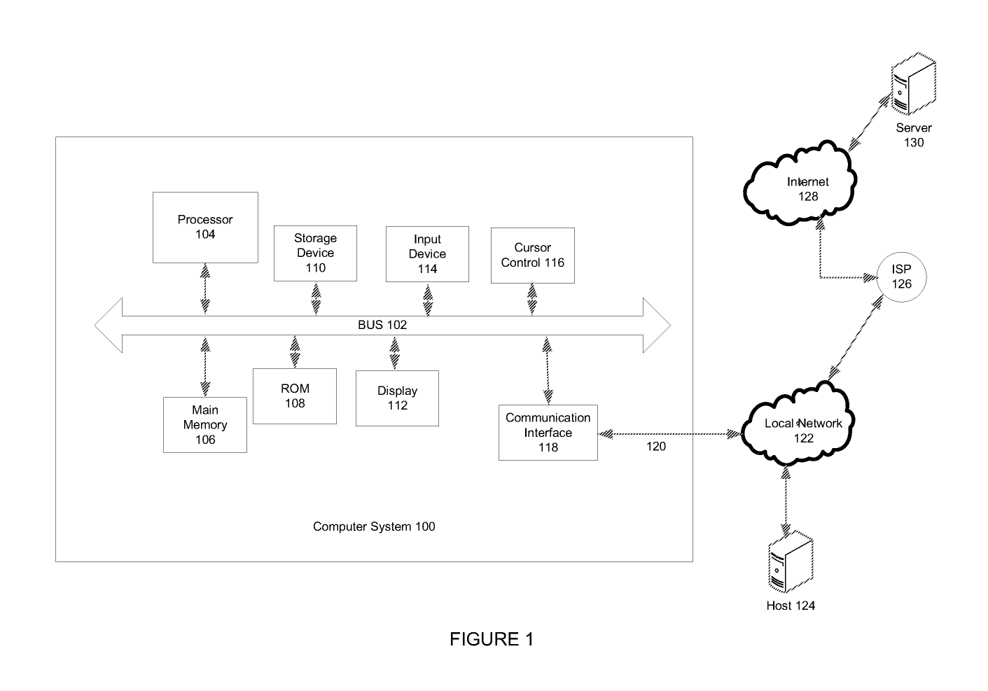

FIG. 1 is a block diagram illustrating an exemplary computer system 100 upon which an embodiment of the invention may be implemented. The present invention is usable with currently available personal computers, mini-mainframes and the like.

Computer system 100 includes a bus 102 or other communication mechanism for communicating information, and a processor 104 coupled with the bus 102 for processing information. Computer system 100 also includes a main memory 106, such as a random access memory (RAM) or other dynamic storage device, coupled to the bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to the bus 102 for storing static information and instructions for the processor 104. A storage device 110, such as a magnetic disk or optical disk, is provided and coupled to the bus 102 for storing information and instructions.

Computer system 100 may be coupled via the bus 102 to a display 112, such as a cathode ray tube (CRT) or a flat panel display, for displaying information to a computer user. An input device 114, including alphanumeric and other keys, is coupled to the bus 102 for communicating information and command selections to the processor 104. Other input devices include audio/video capture devices. Another type of user input device is cursor control 116, such as a mouse, a trackball, or cursor direction keys for communicating direction information and command selections to processor 104 and for controlling cursor movement on the display 112. This input device typically has two degrees of freedom in two axes, a first axis (e.g., x) and a second axis (e.g., y) allowing the device to specify positions in a plane.

The invention is related to the use of a computer system 100, such as the illustrated system, executing sequences of instructions contained in main memory 106. Such instructions may be read into main memory 106 from another computer-readable medium, such as storage device 110. However, the computer-readable medium is not limited to devices such as storage device 110. For example, the computer-readable medium may include a floppy disk, a flexible disk, hard disk, magnetic tape, or any other magnetic medium, a CD-ROM, a DVD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 106 causes the processor 104 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 100 also includes a communication interface 118 coupled to the bus 102. Communication interface 108 provides a two-way data communication as is known. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. In the preferred embodiment communication interface 118 is coupled to a virtual blackboard. Wireless links may also be implemented. In any such implementation, communication interface 118 sends and receives electrical, electromagnetic or optical signals which carry digital data streams representing various types of information. For example, two or more computer systems 100 may be networked together in a conventional manner with each using the communication interface 118.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication services through the world wide packet data communication network now commonly referred to as the “Internet” 128. Local network 122 and Internet 128 both use electrical, electromagnetic or optical signals which carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. In accordance with the invention, one such downloaded application provides for information discovery and visualization as described herein.

The received code may be executed by processor 104 as it is received, and/or stored in storage device 110, or other non-volatile storage for later execution. In this manner, computer system 100 may obtain application code in the form of a carrier wave.

In accordance with embodiments of the present invention, computer system 100 (or a similar system) is provided with a program that facilitates playback of DVDs or other storage media on which per-recorded movies are stored. Alternatively, the movies may be stored on a hard disk or other storage medium. The movies may be stored in any convenient format, for example MPEG-2, MPEG-4, DVD, or other formats common in the motion picture and digital video arts. The precise nature of the storage format is not critical to the present invention. The program that facilitates playback of the movie (from whichever storage medium is used) will be referred to as a Player.

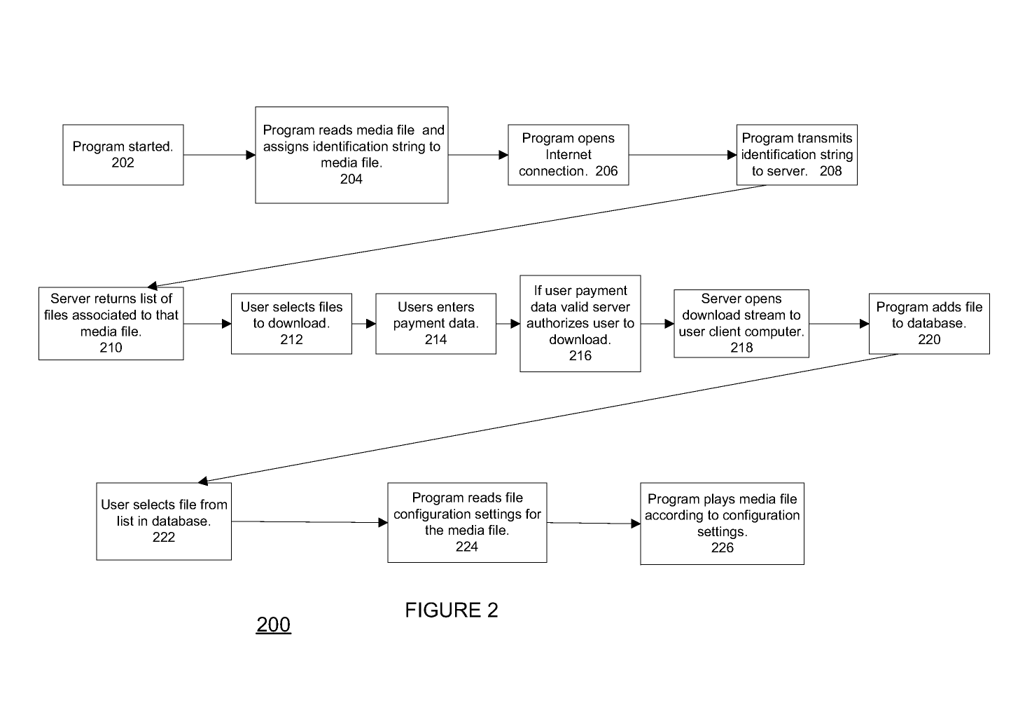

Aspects of the present invention are perhaps best understood in the context of the movieoke user experience. FIG. 2 is a flow diagram illustrating various aspects of such a user experience. It should be remembered, however, that this particular flow is intended only as an example and that other forms of the user experience (e.g., flows involving a hosted playback/recording) may be used in accordance with the present invention.

Process 200 beings with a user initiating or launching the Player program at his/her computer system (202). Typically, the Player program will be stored locally at the computer system, but in some cases it may be an on-line or hosted application that executes remotely from the user's computer system when accessed through a local client application or browser. Alternatively, the Player may be stored at a server communicatively coupled to the user's local computer system via a local area or other network (e.g., a SOHO network). In this context, a server may be any form of computer system.

The Player program reads the media file which includes the scene which the user wishes to participate in (204). As indicated above, the media file may be stored on any convenient storage medium, such as a DVD, CD-ROM, hard disk, flash drive or other storage medium. Typically, the media file will be a pre-recorded movie (possibly with other elements such as previews, copyright warnings, etc., stored on the same media) with audio and video tracks. These tracks may be stored separately or collectively, depending on the type of recording format used. In addition, other tracks, such as a second audio program, subtitles, alternative camera angles, etc., may also be included in the media file, either as separate tracks or embedded in the audio or video tracks.

The Player assigns an identification string to the media file. The identification string is determined according to the content of the media file read by the Player. The Player then opens an Internet connection (e.g., by causing a browser at the user's computer to open or by launching a browser included with the Player) and contacts a remote server (206). The remote server hosts a movieoke service, which includes a database of scenes for which control files can be provided. The control files facilitate the movieoke experience by controlling the Player program and the playback of the media file as described more fully below.

In order to obtain a list of available scenes for the subject media file, the Player provides the host server with the identification string therefor (208). In response, the host server uses the identification string as an index to retrieve from its database a list of available scenes for the subject media file (210). The list may be presented to the user in any convenient fashion, for example in the user's browser.

The user can thus select one or more scenes for the movieoke experience (212) and, after completing a payment process in which the user's payment information is verified (214, 216), download the associated control files to the user's local computer system (218). The control file may be added to a local database at the user's computer (220), which database is accessible by the Player. For example, the database may be stored on hard disk and/or memory at the user's computer.

Once the control file has been downloaded, the user selects the control file from the database (222). Such selection may be made through the Player, for example by opening the selected file from a menu or other user interface. The Player uses (reads) the control file to understand how the media file is to be played back (224). Playback of the media file then occurs according to this configuration information (226).

The control file downloaded from the server may be regarded as a sequence of instructions to the Player. These instructions determine the portions of the media file that are to be played back. For example, the instructions may include information regarding the portions of the audio and/or video tracks that are to be played—i.e., those portions that correspond to the scene of the movie that the user has selected to participate in. Thus, specific instructions regarding a time index to commence audio/video playback, instructions regarding when to mute an audio portion of a soundtrack, and instructions regarding when to stop playback may be included in the control file.

The control file may also include instructions regarding a destination file for audio and/or video files that represent the user interaction. That is, the audio/video recordings made by the user may be stored to a destination file on the user's computer (e.g., on the hard disk or in memory) as determined by and under the control of the control file. In this way, during later playback the control file can insert the user-generated content in place of the pre-recorded movie content during the scene of interest.

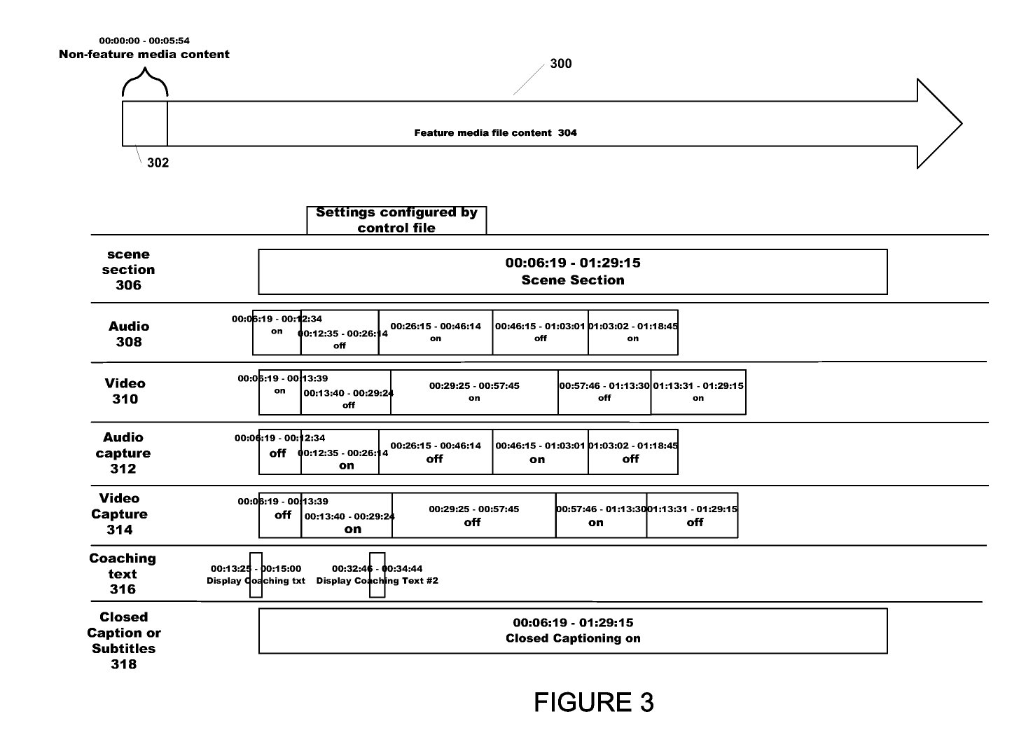

As indicated, the user-generated content may include audio and/or video content. To better understand how this content is captured and later played, consider first the situation depicted in FIG. 3. This illustration represents a timeline of playback of the media file and capture of the user-generated audio/video content. At the top is shown the entire media file 300. The media file may include such things as trailers for other features, copyright warnings, etc. These are indicated at the left edge of the media file timeline 300 as “non-feature media content” 302. The markings 00:00:00-00:03:18 correspond to time stamps or other indicators used to denote the length of such non-feature media content. The media file 300 also includes the feature media content 304.

Immediately below the media file timeline 300 is a timeline 306 representing the scene of interest 306 as selected by the user. This will be a scene from somewhere within the media file timeline. Many such scenes may be included in a single media file. In this case, the scene of interest commences at timestamp 00:06:19 and ends at timestamp 01:29:15. The control file downloaded to the user's computer will include computer-readable instructions for how this scene is to be played and when audio/video capture of the user content is to be made. In addition, instructions for the display of subtitles (e.g., highlighted so as to indicate when the user should speak lines of dialog) may also be included. Subtitles or closed caption information may be played in any selected language. So too may additional materials, such as prompts of other on-screen displays of script notes, be included. These script notes may provide additional information about the scene of interest to the user. For example, the notes may explain the character's motivation, the background to the scene, a discussion of how the user should speak the dialog, etc. In some cases the script notes will be included in files separate from the control file (e.g., text files). In such cases, the script notes may be downloaded separately from the control file (or in a single package including the control file) and reviewed separately from the media file/scene. For example, the script notes may be printed in hard copy for the user to refer to and not displayed on screen.

Immediately below the scene timeline 306 are shown timelines for the audio tracks 308 and video tracks 310 that make up the scene of interest. In each of these tracks the label “on” indicates that the control file includes instructions for the Player to render perceptible (i.e., play) the designated portion of the respective track. The label “off” indicates that the control file includes instructions for the Player to render imperceptible (e.g., mute in the case of audio) the designated portion of the respective track. The different portions of the tracks are indicated by timestamp. So, for example, the portion of the audio track 308 from timestamp 00:06:16 to 00:12:34 will be rendered perceptible by the Player, but the portion of the audio track 308 from timestamp 00:12:35 to 00:26:14 will be rendered imperceptible. This portion of the audio track likely includes the dialog spoken by the character which the user will now personify and the user will be expected to speak the lines of dialog (or any other lines he/she wishes, e.g., for parody purposes) during this time. Such audio may be recorded for later playback in context of the scene, as discussed below.

Similarly, the portion of the video track 310 from timestamp 00:06:16 to 00:13:39 will be rendered perceptible by the Player, but the portion of the video track 310 from timestamp 00:13:40 to 00:29:24 will be rendered imperceptible. This portion of the video track likely includes the video of the character which the user will now personify and the user will be expected to record him/herself (or any other video he/she wishes) during this time. Such video may be recorded for later playback in context of the scene, as discussed below.

As shown in the illustration, the control file also includes instructions for the audio/video capture 312, 314 from peripherals associated with the user's computer system. Such capture may be effected using conventional audio/video capture devices, such as microphones, video cameras, web cameras, etc. Notice that the “on” and “off” instructions for the audio and video capture correspond to the “off” and “on” instructions, respectively, for the audio and video playback from the media file. This helps ensure that during the later playback the user-generated content may be inserted accurately and seamlessly into to playback of the media file. The captured audio/video information may be subject to further processing to add effects, change backgrounds, add features, etc. Such audio/video processing may, in part, be accomplished through the use of chroma keying as is well known in the art.

It should be appreciated that the capture and playback of user-generated audio content may be performed independently of the capture and playback of user-generated video content. That is, either or both of such processes may be performed. Such audio/video capture and playback may be subject to one or more licensing agreements with the owners of the original media content and/or permitted only in certain instances, for example for educational purposes in connection with language training.

Also shown in FIG. 3 is the on-screen display of coaching text (e.g., script notes) 316 during the playback of the media file. As indicated above, where such script notes or other content are available for playback, the Player may be instructed to so play the content to assist the user in achieving an enjoyable movieoke experience. The content associated with the coaching text may be included in the control file or may be a separate file accessed by the Player in accordance with the playback instructions. In addition, as shown in this example, the Player may be instructed to play closed caption information or subtitles 318 so that the user can read his/her lines at the appropriate time. The closed caption information may be played throughout the scene (as shown) or only at time appropriate for the user to speak/act.

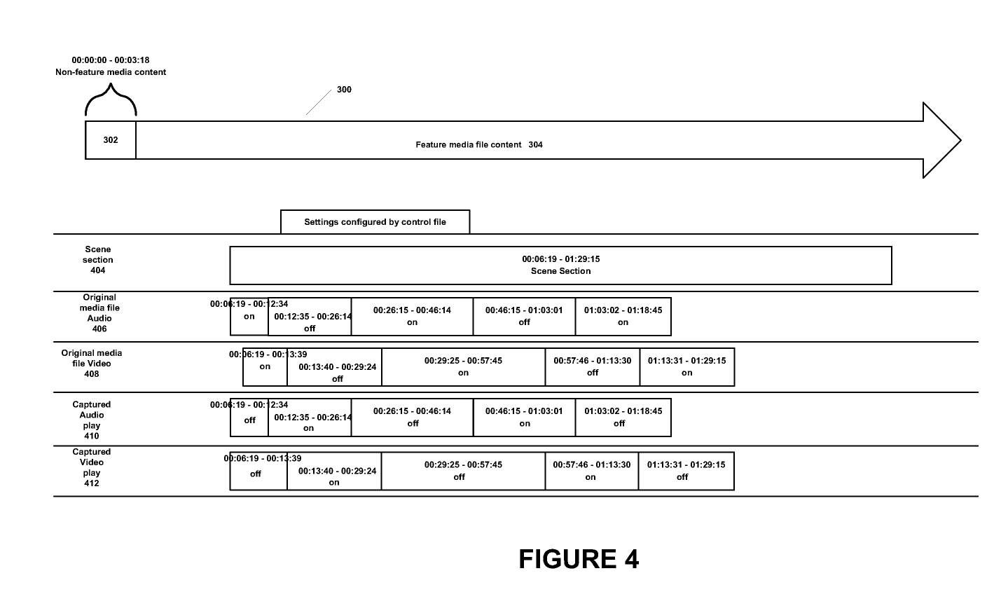

Turning now to FIG. 4, an example of the replay of the scene of interest to include the user-generated content is shown. Again, the timeline format is used for illustration purposes. Here, the scene of interest 404 runs from timestamp 00:06:19 to 01:29:15. The control file is configured to instruct the Player to play the audio/video tracks 406, 408 of the media file at and for the designated periods. For example, the media file audio track 406 will be rendered perceptible from 00:06:19 to 00:12:34, then rendered imperceptible from 00:12:35 to 00:26:14, then rendered perceptible from 00:26:15 to 00:46:14, and so on. The video track 408 will be rendered perceptible from timestamp 00:06:19 to 00:13:39, then rendered imperceptible from 00:13:40 to 00:29:24, then rendered perceptible from 00:29:25 to 00:57:45, and so on.

The control file is further configured to instruct the Player to play previously captured user-generated audio/video content 410, 412 at and for the designated periods. Such content may have been captured in the manner described above and stored in a file accessible by the user's computer system (e.g., on hard disk, in memory, or even stored to a remote location accessible via a network connection or through the Internet). So, for example, the user-generated audio track 410 will be rendered imperceptible (or simply not played) from timestamp 00:06:19 to 00:12:34, then rendered perceptible from 00:12:35 to 00:26:14, then rendered imperceptible (or not played) from 00:26:15 to 00:46; 14, and so on. Note, the user-generated content may or may not be captured with timestamp information. If timestamp information is captured, e.g., as determined from the playback of the original media file, synchronizing of the files (the media file and the user generated content file(s)) may be accomplished on that basis. If no such timestamp information is captured then the user generated content file(s) may simply be played at and for the indicated durations under the control of the control file (which may make use of the timestamp information from the media file). The previously captured user generated video track 412 will be rendered imperceptible from timestamp 00:06:19 to 00:13:39, then rendered perceptible from 00:13:40 to 00:29:24, then rendered imperceptible from 00:29:25 to 00:57:45, and so on. Note, the user generated content need not be separated into different tracks but is shown as such in the diagrams for purposes of explanation.

Subtitles, closed caption information and script notes, etc. need not be played back during this portion of the movieoke experience because the user generated content has already been captured and is now being played in the context of the original scene. Note, the original media file 300 is not altered in the context of the movieoke experience. Rather, it is simply supplemented by the user generated content at and for brief periods of time corresponding to the dialog and/or on-screen moments of the character which the user is personifying.

It should be recognized that the above-described playback of previously captured user content may also apply in the case of real-time captured user content. That is, rather than recording the user content for later playback, such playback may occur at the same time as the content is being captured, for example during a performance by the user. This facilitates “live” movieoke experiences. In addition, where the user-generated content is captured, it may be forwarded to others for review (either separately or as part of a movieoke experience). In this way users can share their content with friends or others. In the educational context, this permits review and critique by instructors.

In some cases, multiple users will participate as different characters in a scene. Accordingly, multiple user audio/video capture may be accommodated in accordance with the above-described procedures. Further, control files for different characters/scenes of a single movie may be provided for download so that users can select their desired character/scene. In this way the movieoke experience can be tailored to the user's desires.

Thus, methods and systems for enhanced movieoke have been described.

What is claimed is:

1. A computer-implemented method, comprising providing, in response to a request designating a scene of interest included in a media file, a control file including instructions for playing of audio and video portions of the scene of interest, which instructions when executed by a computer system, cause the computer system to play the audio and video portions intermixed with capture of user-generated audio and video information provided as inputs to the computer system at designated times during the playing of the audio and video portions.

2. The method of claim 2, wherein the control file further includes instructions that when executed by the computer system, cause the computer system to display subtitles highlighted so as to indicate when a user should speak lines of dialog appropriate to the scene of interest.

3. The method of claim 1, wherein the control file further includes instructions that when executed by the computer system, cause the computer system to display script notes, regarding the scene of interest.

4. The method of claim 1, further comprising providing to the computer system a file including script notes regarding the scene of interest, said file being separate from the control file.

5. The method of claim 1, wherein the instructions, when executed by the computer system, cause the computer system to play the media file so as to render perceptible the audio and video portions at some times during the playing of the media file and to render imperceptible the audio and video portions at other times during the playing of the media file.

6. The method of claim 5, wherein the instructions, when executed by the computer system, cause the computer system to record the user-generated audio information during the times the audio portion of the media file is rendered imperceptible during playing of the media file.

7. The method of claim 5, wherein the instructions, when executed by the computer system, cause the computer system to record the user-generated video information during the times the video portion of the media file is rendered imperceptible during playing of the media file.

8. The method of claim 5, wherein the instructions, when executed by the computer system, cause the computer system to record the user-generated audio and video information during the times the audio and video portions of the media file are rendered imperceptible during playing of the media file.

9. The method of claim 8, wherein the instructions, when executed by the computer system, cause the computer system to display of coaching text during the playing of the media file.

10. A computer-implemented method, comprising playing a scene of interest from a media file so as to render perceptible audio and video portions of the scene of interest at some times during the playing of the media file and to render imperceptible the audio and video portions of the scene of interest at other times during the playing of the media file, and recording user-provided audio and video information during those times the audio and video portions of the scene of interest are rendered imperceptible during playing of the media file.

11. The method of claim 10, further comprising displaying coaching text during the playing of the media file.

12. The method of claim 11, wherein the coaching text comprises subtitles highlighted so as to indicate when a user should speak lines of dialog appropriate to the scene of interest.

13. The method of claim 11, wherein the coaching text comprises script notes regarding the scene of interest.

14. A computer-implemented method, comprising playing audio and video portions of a scene of interest of a media file and playing user-generated content, the playing of the audio and video portions and the user-generated content being arranged in time so that the audio and video portions of the scene of interest are rendered perceptible at and for first designated periods of time and are rendered imperceptible at and for second designated periods of time, and designated portions of the user-generated content are played during the second designated periods of time when the audio and video portions of the scene of interest are rendered imperceptible.

15. The method of claim 14, wherein the user-generated content is played from a stored copy thereof.

16. The method of claim 14, further comprising displaying coaching text during the playing of the scene of interest of the media file.

17. The method of claim 16, wherein the coaching text comprises subtitles highlighted so as to indicate when a user should speak lines of dialog appropriate to the scene of interest.

18. The method of claim 16, wherein the coaching text comprises script notes regarding the scene of interest.

19. The method of claim 14, wherein the playing of the audio and video portions of the scene of interest of the media file and the playing of the user-generated content is performed under the control of a file provided in response to a request therefor.

20. The method of claim 19, wherein the request specifies the scene of interest as a selection from a list of scenes available for the media file.
